(19) United States
(12) Patent Application Publication
(10) Pub. No.: US 2005/0150762 A1
(43) Pub. Date: Jul. 14, 2005

(54) Biosensor and method of manufacture

(76) Inventors: Colin W. Butters, Ipswich (GB); Wah On Ho, Colchester (GB); John J. Rippeth, Ipswich (GB)

Correspondence Address: O'KEEFE, EGAN & PETERMAN, L.L.P.;Suite 200, Building C, 1101 Capital of Texas Highway South, Austin, TX, 78746, US

(21) Appl. No.: 11/028,941

(22) Filed: Jan. 4, 2005

Related U.S. Application Data
(60) Provisional application No. 60/535,430, filed on Jan. 9, 2004.

(51) Int. Cl. G01N 27/26

(52) U.S. Cl. 204/403.01; 204/403.14

(57) ABSTRACT

A biosensor (20) for indicating electrochemically the catalytic activity of an enzyme in the presence of a biological fluid containing an analyte acted upon by said enzyme comprises:
(a) a first substrate (2);
(b) a second substrate (18) overlying at least a part of the first substrate (2);
(c) a working electrode (24) on one of the substrates, the working electrode (24) including a catalytically-active quantity of said enzyme;
(d) a counter electrode (22) on one of the substrates;
(e) conductive tracks (4, 6) connected to said working (24) and counter (22) electrodes for making electrical connections with a test meter apparatus;
(f) a spacer layer (14) having a channel (16) therein and disposed between the first substrate (2) and the second substrate (18), the spacer layer channel (16) co-operating with adjacent surfaces to define a capillary flow path which extends from an edge of at least one of said substrates (2, 18) to said electrodes (22, 24);
   wherein the electrodes (22, 24) are arranged such that a fluid sample which flows along the capillary flow path from said edge will substantially completely cover the working electrode (24) before the fluid sample makes contact with any part of the counter electrode (22).

This application claims priority to co-pending U.S. provisional application Ser. No. 60/535,430 filed on Jan. 9, 2004, which is entitled “BIOSENSOR AND METHOD OF MANUFACTURE”, the disclosure of which is incorporated herein by reference.

### BACKGROUND OF THE INVENTION

1. Field of the Invention

The present invention relates to a biosensor for measuring analyte concentration in biological fluids, for example glucose in whole blood. The invention also provides a method of manufacturing the biosensor. Biosensors typically include an enzyme electrode comprising an enzyme layered on or mixed with an electrically conductive substrate. The electrodes respond electrochemically to the catalytic activity of the enzyme in the presence of a suitable analyte.

2. Description of the Prior Art

Electrochemical biosensors are well known in the art. They are used in measurement techniques including amperometry, coulometry and potentiometry. Typically the enzyme is an oxidoreductase, for example glucose oxidase, cholesterol oxidase, or lactate oxidase, which produces hydrogen peroxide according to the reaction:
analyte+O₂-[oxidase]→oxidised product+H₂O₂.

In an amperometric measurement, the peroxide is oxidised at a fixed-potential electrode as follows:
H₂O₂→O₂+2H⁺+2e⁻.

Electrochemical oxidation of hydrogen peroxide at platinum centres on the electrode results in transfer of electrons from the peroxide to the electrode producing a current which is proportional to the analyte concentration. Where glucose is the analyte, the oxidised product is gluconolactone.

In coulometric measurement, the current passed during completion or near completion of electrolysis of the analyte is measured and integrated to give a value of charge passed. The charge passed is related to the quantity of analyte present in a sample so that if the sample volume is known the analyte concentration can be determined. In potentiometric measurement, a potential generated by the reaction is measured at one or more points in time and related to the initial analyte concentration. The various electrochemical measurement techniques are well known to those skilled in the art.

Typically, electrochemical measurement begins automatically when the fluid sample completes an electrical circuit between the working and counter electrodes. Getting an accurate reading can be a problem when a blood sample incompletely covers the working electrode because the amount of current or measured charge is less than when the working electrode is fully covered. If a user attempts to top-up the sample by applying a second drop of blood (‘double-dosing’) this has the effect of reducing the precision of the measurement and increasing the response as the addition of extra blood causes a non-faradaic charging peak to occur when more of the electrode area is covered by the second sample.

It has been proposed to reduce the problem of incomplete fill by employing a pair of fill-detection electrodes in the fluid path, with the working and counter electrodes inbetween. A measurement is only taken when a circuit has been completed between the fill electrodes. However, this arrangement adds complexity to the system and does not address the problems of double-dosing by the user.

The present invention seeks to reduce at least some of the above problems.

### SUMMARY OF THE INVENTION

According to an aspect of the invention there is provided a biosensor for indicating electrochemically the catalytic activity of an enzyme in the presence of a biological fluid containing an analyte acted upon by said enzyme, the biosensor comprising:
(a) a first substrate;
(b) a second substrate overlying at least a part of the first substrate;
(c) a working electrode on one of the substrates, the working electrode including a catalytically-active quantity of said enzyme;
(d) a counter electrode on one of the substrates;
(e) conductive tracks connected to said working and counter electrodes for making electrical connections with a test meter apparatus;
(f) a spacer layer having a channel therein and disposed between the first substrate and the second substrate, the spacer layer channel co-operating with adjacent surfaces to define a capillary flow path which extends from an edge of at least one of said substrates to said electrodes;
   wherein the electrodes are arranged such that a fluid sample which flows along the capillary flow path from said edge will substantially completely cover the working electrode before the fluid sample makes contact with any part of the counter electrode.

Locating the working electrode before any part of the counter electrode in the capillary flow path ensures that an electrical circuit is not completed until the working electrode has been covered by a fluid, notably whole blood. We have surprisingly found that sufficiently accurate measurements can be taken when only a part of the counter electrode is covered with the fluid provided that the working electrode is fully covered.

Preferably the working electrode is the first electrode that a fluid sample will encounter when it flows through the capillary flow path. Additional fill-detection electrodes could be provided but are not necessary because adequate filling will be indicated when an electrical connection is established between the working and counter electrodes.

This arrangement also allows double-dosing without loss of precision or increased values resulting from an extra non-faradaic charging peak. Because the first dose does not complete the circuit between the working and counter electrode only a single non-faradaic charging peak occurs, after sufficient extra sample fluid has been added in a second or subsequent dose.

The spacer may be relatively thin, for example 60-120 μm to reduce the capillary flow path volume so the biosensor may require smaller sample volumes. This enables the biosensor to be used at alternative sample sites on a subject's body. A blood sample is typically taken by pricking a subject's finger to provide a relatively large drop of blood for application to a conventional biosensor. Because a fingertip has a relatively large number of nerve endings, pricking the fingertip can be painful and deters some subjects from testing their blood glucose level often enough. A biosensor in accordance with the present invention may be used to take a reading from an alternative site, for example a subject's upper arm which has fewer nerve endings so that sampling is less painful. The sample volume to cover the working electrode and make an electrical connection with the counter electrode may be as low as about 0.5 μl.

To facilitate collection of small sample volumes it is preferred that the capillary flow path runs from parallel edges of both substrates to the electrodes, so that there is no lip where one substrate extends beyond the other at the point where the sample is introduced into the biosensor. The presence of a lip provides a wasted space on which some or all of the sample may remain.

The capillary flow path typically runs from an edge of a substrate to a vent aperture or opening, for example a hole or slit in one of the substrates, or an opening at a different edge, for example at an opposite edge for a side-fill biosensor. The working and counter electrodes lie within the capillary flow path.

To encourage capillary filling of the biosensor at least one of the major surfaces defining the capillary flow path should be hydrophilic so that it is readily wetted by a biological fluid such as whole blood. Preferably, each major surface is hydrophilic. A porous mesh may optionally be provided in the capillary flow path, as is known per se for capillary-fill biosensors.

Any known working electrode may be used in the present invention, whether mediated or non-mediated. In a preferred embodiment, the working electrode comprises an electrically-conductive layer comprising particles of a platinum-group metal or platinum-group metal oxide bonded together by a resin, a top layer comprising a buffer on the base layer, and a catalytically-active quantity of an oxidoreductase enzyme in at least one of the top layer and the base layer. The working and counter electrodes may be manufactured as described in WO 2004/008130, the contents of which are incorporated herein by reference. We have found that by providing a buffer in the top layer, we can get faster response times than conventional non-mediated biosensors, together with increased stability and sensitivity. The increase in sensitivity and response time we believe is achieved by providing a high buffering capacity on the strip. The oxidation of hydrogen peroxide produces hydrogen ions which are neutralised by the buffer. This can have two effects: it sustains enzyme activity by maintaining the local pH around the enzyme, and it also shifts the equilibrium of the hydrogen peroxide oxidation making it more efficient. Improving the efficiency of hydrogen peroxide oxidation also results in greater oxygen recycling which can be utilised by the oxidoreductase enzyme. We have also found that the ratio of enzyme to buffer is important in obtaining a desirable linearity of response and to obtain a reasonable lower limit of sensitivity. We have further found that the buffer and enzyme needs to exceed a particular threshold concentration to attain the maximum sensitivity and above this concentration the ratio of buffer to enzyme can be used to ‘tune’ the profile of the response of the biosensor to blood glucose. Preferred buffers include: phosphate, ADA, MOPS, MES, HEPES, ACA, and ACES, or buffers with a pKa 7.4±1. The pH range for the buffer will depend on the specific chemistry of the system. A preferred range is pH 7-10, notably 7 to 8.5. Particularly preferred buffers are phosphate, at about pH 8, and ADA at about pH 7.5.

The platinum group metal or oxide may be present in sufficient quantity for the base layer to be electrically conductive, as taught in U.S. Pat. No. 5,160,418. Alternatively, the base layer may also contain particles of finely divided carbon or graphite. For convenience, the term ‘catalyst’ will be used herein to refer to the finely divided platinum-group metal or platinum-group metal oxide. The catalyst may be carried on the surface of the carbon or graphite particles. In a preferred embodiment, the catalyst is in intimate surface contact with the carbon or graphite particles, for example as platinised carbon or palladised carbon. The catalyst may be adsorbed, crystallised or deposited on the surface of the particles.

The resin may comprise any compatible binder material or bonding agent which serves to bond the platinum group metal or oxide in the base layer; for example, a polyester resin, ethyl cellulose or ethylhydroxyethylcellulose (EHEC).

The working electrode may be manufactured by printing an ink containing the catalyst on the base substrate, allowing the printed ink to dry to form a base layer, and subsequently forming the top layer by applying a coating medium comprising or containing the buffer. The coating medium is preferably a fluid, notably an aqueous fluid in which the buffer is dissolved. However, the coating medium could comprise a dry powder consisting of or containing the buffer, which is applied, for example by spraying, to a tacky base layer. Suitable methods for forming the top layer when a coating fluid is applied include printing, spraying, ink jet printing, dip-coating or spin-coating. A preferred coating technique is drop-coating of a coating fluid, and the invention will be described hereinafter with reference to this preferred method. By accurately drop-coating a coating fluid onto the base layer, the volume of coating fluid required may be reduced, for example to 125 nl.

In a preferred embodiment, the enzyme is provided in the top layer with the buffer. This arrangement facilitates adjustment of the pH in the local environment of the top layer to a level at which the enzyme may operate more efficiently, which level is typically different from that at which the platinum group metal or oxide optimally operates.

A system stabiliser may advantageously be included in the top layer. Suitable stabilisers include polyols other than those which are acted upon by the enzyme; for example trehalose, mannitol, lactitol, sorbitol or sucrose where the enzyme is glucose oxidase. The system stabiliser may stabilise the enzyme by encapsulation, hindering tertiary structural changes on storage, or by replacing the water activity around the enzyme molecule. The glucose oxidase enzyme has been shown to be a very stable enzyme and the addition of stabilisers are not primarily to protect this enzyme. The stabiliser is believed to help reduce long term catalyst passivation effects, for example by coating a platinised carbon resin base layer as well as blocking the carbon surface to air oxidation.

If carbon particles are present in the base layer, a blocking agent may optionally be included in that layer to block active sites on the carbon particles. This aids shelf stability and uniformity of the carbon's activity. Suitable blocking agents include the system stabilisers and also proteins, for example bovine serum albumin (BSA). If graphite particles are used instead of high surface carbon, the particles have higher conductivity, and a blocking agent is less desirable because the number of active moieties on the graphite is much less than that found on carbon. The smaller surface area and less active surface groups both tend to reduce the intercept. At 0 mM of analyte the intercept consists mainly of a capacitative component which is surface area related.

The substrates may be formed from any suitably heat-stable material which is compatible with the coating to be applied. Heat stability is important to ensure good registration of prints in the manufacturing process. A preferred substrate is Valox FR-1 thermoplastic polyester film (poly(butylene terephthalate) copoly(bisphenol-A/tertabromobisphenol-A-carbonate). Other suitable substrates will be well known to those skilled in the art, for example PVC, poly(ether sulphone) (PES), poly(ether ether ketone) (PEEK), and polycarbonate.

Any suitable enzyme may be employed. Preferred oxidoreductase enzymes include glucose oxidase, cholesterol oxidase, or lactate oxidase.

According to another aspect of the present invention there is provided a method of manufacturing a biosensor for indicating electrochemically the catalytic activity of an enzyme in the presence of a biological fluid containing a substance acted upon by said enzyme, the method comprising the steps of:
providing a first substrate and a second substrate overlying part of the first substrate;
one of said substrates having a working electrode thereon including a catalytically active quantity of said enzyme and one of said substrates having a counter electrode thereon, each of said electrodes having a conductive track connected to it for making an electrical connection with a test meter apparatus;
providing a spacer layer having a channel therein and disposed between the first substrate and the second substrate, whereby the spacer layer channel and adjacent surfaces together define a capillary flow path which extends from an edge of at least one of said substrates to said electrodes;
wherein the electrodes are arranged such that a fluid sample which flows along the capillary flow path from said edge will substantially completely cover the working electrode before the fluid sample makes contact with any part of the counter electrode.

Other aspects and benefits of the invention will appear in the following specification, drawings and claims.

### BRIEF DESCRIPTION OF THE DRAWINGS

The invention will now be further described, by way of example, with reference to the following drawings in which:

FIG. 1 shows stages in the formation of a comparative biosensor not forming part of the present invention;

FIGS. 2 and 3 show stages in the formation of biosensors in accordance with embodiments of the present invention;

FIG. 4 is a graph showing current responses of the biosensors of FIGS. 1-3 for samples of venous blood having different glucose concentrations;

FIG. 5 is a graph showing sample volume dependency for a comparative biosensor not forming part of the present invention;

FIG. 6 is a graph showing sample volume dependency for biosensors in accordance with embodiments of the present invention;

FIGS. 7 and 8 are graphs showing the effect of double dosing on a biosensor in accordance with an embodiment of the invention and a comparative biosensor;

FIGS. 9 and 10 are graphs of normal and double dose transient currents for a comparative biosensor;

FIGS. 11-14 are graphs of calibrations for single and double dosing of a biosensor in accordance with an embodiment of the present invention and a comparative biosensor;

FIG. 15 graphs bias as a function of double dose intervals for a biosensor in accordance with an embodiment of the invention at different blood glucose concentrations; and

FIGS. 16-19 are graphs showing the effects of double dosing on a new and a comparative biosensor under different conditions.

### DETAILED DESCRIPTION

When used herein, the following definitions define the stated term:

“Amperometry” includes steady-state Amperometry, chronoamperometry, and Cottrell-type measurements.

A “biological fluid” is any body fluid in which the analyte can be measured. Examples include blood, sweat, urine, interstitial fluid, dermal fluid, and tears.

A “biosensor” is a device for detecting the presence or concentration of an analyte in a biological fluid by means of electrochemical oxidation and reduction reactions transduced to an electrical signal that can be correlated to the presence or concentration of analyte.

“Blood” includes whole blood and fluid components of whole blood, for example plasma and serum.

“Coulometry” is the determination of charge passed or projected to pass during complete or near-complete electrolysis of the analyte. The determination may be made using a single measurement or multiple measurements of a decaying current and elapsed time during electrolysis of a sample.

A “counter electrode” is one or more electrodes paired with the working electrode, through which passes a current equal in magnitude and opposite in sign to the current passed through the working electrode. The term includes counter electrodes which also function as reference electrodes.

“Electrolysis” is the electrooxidation or electroreduction of a compound either directly at an electrode or via one or more mediators.

A “faradaic current” is a current corresponding to the reduction or oxidation of a chemical substance. The net faradaic current is the algebraic sum of all the faradaic currents flowing through a working electrode.

“Potentiometry” is the measurement of electrical potential under conditions of low or no current flow, which may be used to determine the presence or quantity of analyte in a fluid.

A “reference electrode” is an electrode that has a substantially stable equilibrium electrode potential. It can be used as a reference point against which the potential of other electrodes, notably the working electrode, can be measured. The term includes reference electrodes which also function as counter electrodes, as is the case in the experimental biosensors of the present application.

A “working electrode” is an electrode at which analyte undergoes electrolysis.

Preparation of BSA-Pt/Carbon

In a 250 ml glass bottle, 6.4 g of BSA, Miles Inc. was dissolved in 80 ml of phosphate buffered saline (PBS) and 20 g of 10% Pt/XC72R carbon, MCA Ltd, was gradually added with constant stirring. The bottle was then placed on a roller mixer and allowed to incubate for two hours at room temperature.

A Buchner funnel was prepared with two pieces of filter paper, Whatman™ No 1. The mixture was poured into the funnel and the carbon washed three times with approximately 100 ml of PBS. The vacuum was allowed to pull through the cake of carbon for about 5 minutes to extract as much liquid as possible. The cake of carbon was carefully scraped out into a plastic container and broken up with a spatula. The carbon was then placed in an oven at 30° C. overnight to dry. The purpose of this procedure is to block active sites on the carbon hence to aid the shelf stability and reproducibility of the carbon's properties.

Preparation of Platinum Group Metal/Carbon Inks

BSA-Pt/Carbon was prepared in Metech 8101 polyester resin as the polymer binder and Butyl Cellosolve Acetate (BCA) as a solvent for the ink.

Ink Formulation

| | |
|---|---|
| Metech 8101 resin | 44.68% |
| BSA-Pt/Carbon | 18.42% |
| graphite | 9.64% |
| BCA/cyclohexanone | 22.94% |
| Tween ® 20 | 2.94% |
| glucose oxidase | 1.38% |

Tween 20 is a surfactant supplied by Sigma-Aldrich. Tween is a registered trade mark of ICI Americas, Inc. The solvent is a 50% v/v mixture of BCA and cyclohexanone. The graphite was Timrex KS 15 (particle size<16 μm), from GS Inorganics, Evesham, Worcs. UK.

The resin, Tween 20, and about half the solvent were initially blended together prior to adding the carbon fraction and the graphite. Initially the formulation was hand-mixed followed by several passes through a triple roll mill. The remaining volume of solvent was then added to the ink and blended to bring the ink to a suitable viscosity for printing.

Preparation of Drop-Coating Solutions

The coating solution is water-based and consists of a high concentration of buffer, preferably phosphate at pH 8. It has been found that buffering capacity is more important than ionic strength. In this example the solution contains glucose oxidase and a system stabiliser, in this example trehalose.

Drop-Coat Solution

| Buffer | KH₂PO₄/K₂HPO₄ | 385 mM, pH 8 | Sigma |
|---|---|---|---|
| Enzyme | Glucose oxidase | 4080 U/ml | Biozyme |
| Stabiliser | Trehalose | 1% | Sigma |

Preferred Ranges

| Buffer | 300-1000 mM, pH 7-10 |
|---|---|
| Enzyme | 500-12000 U/ml (1.85-44.4 mg/ml) |
| Stabiliser | 0.5-30% |

The activity of the glucose oxidase is about 270 units per milligram of material (360 units/mg of protein because the enzyme comes in a preparation with other lyophilisation and stabilisation agents).

If the enzyme is located in the base layer the drop coating solution may contain only buffer, optionally with the stabiliser.

Methods of Manufacture

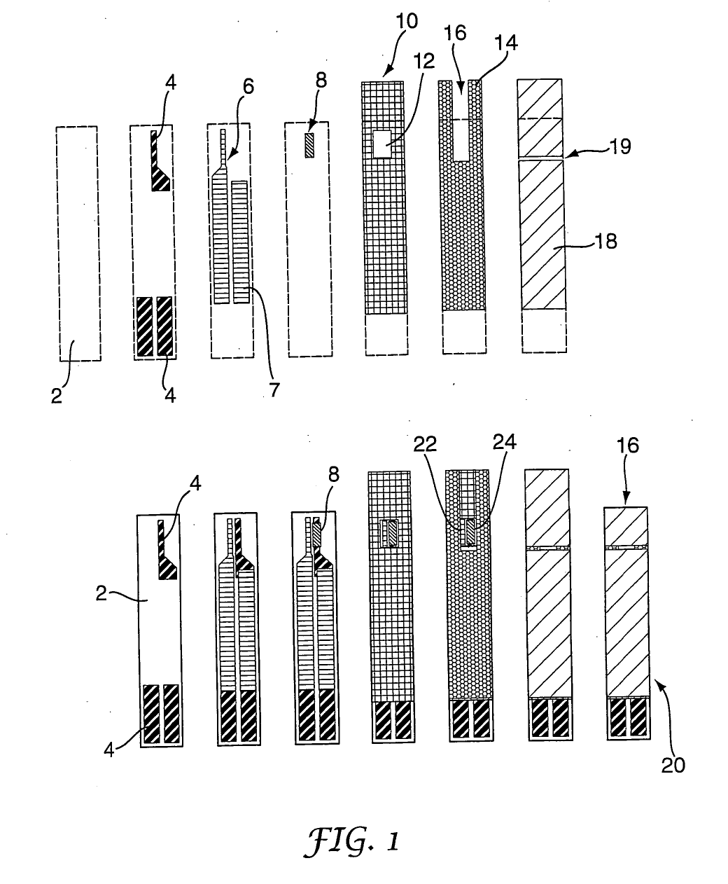

Glucose test strips (biosensors) were manufactured using a combination of screen printing and drop coating technologies. Other printing and/or coating technologies, well known per se to those skilled in the printing and coating arts may also be used. The exemplified methods are by way of illustration only. It will be understood that in each case the order of performance of various steps may be changed without affecting the end product. For each of FIGS. 1-3 the top row illustrates a process step, and the bottom row illustrates the sequential build-up of the biosensor.

With reference to the comparative biosensor shown in FIG. 1, a base substrate 2 is formed from a polyester (Valox™). Conductive tracks 4 were printed onto the substrate 2 as a Conductive Carbon Paste, product code C80130D1, Gwent Electronic Materials, UK. The tracks 4 provide electrical connections between the meter (not shown) and the reference and working electrodes. After printing, the ink of the conductive tracks 4 was dried for 1 minute in a forced air dryer at 130° C. The second ink printed on top of the conductive carbon 4 is a Silver/Silver Chloride Polymer Paste, product code C61003D7, Gwent Electronic Materials, UK. This ink 6 is not printed over the contact area or the working area. The ink 6 forms the silver/silver chloride reference electrode 22 of the system and also connects the conductive carbon regions 4 which will provide an electrical connection between the working electrode 24 and the meter. It is dried at 130° C. in a forced air dryer for 1 minute.

The next layer is the platinum group metal carbon ink which is printed onto the conductive carbon 4 where the working electrode 24 is to be formed. This ink is dried for 1 minute at 90° C. in a forced air dryer to form a conductive base layer 8 about 12 μm thick. A dielectric layer 10 is then printed, excluding a working area 12 in which the working 24 and reference 22 electrodes are to be located. The dielectric layer 10 is MV27, from Apollo, UK. The purpose of this layer is to insulate the system. It is dried at 90° C. for 1 minute in a forced air dryer. If desired, the base layer 8 can alternatively be printed after the dielectric layer 10. However, it is preferred to print the base layer 8 first, since the subsequent application of the dielectric layer 10 removes some of the tolerance requirements of the print.

A drop-coat layer is applied to the base layer 8 using BioDot drop-coating apparatus. The volume of drop-coating solution used is 125 nl, applied as a single droplet; the drop-coat layer is dried in a forced air dryer for 1 minute at 50° C. to form the working electrode 24. After drop-coating, the partially-constructed test strips were allowed to condition for four days at room temperature and low humidity.

A spacer layer 14 is applied over the dielectric layer 10. In the example shown in FIG. 1 the spacer layer 14 is formed from double-sided adhesive tape of thickness about 90 μm. The tape was Adhesives Research 90118, comprising a 26 μm PET carrier with two 32 μm AS-110 acrylic medical-grade adhesive layers. The spacer 14 has a channel 16 which will determine the capillary flow path of the biosensor. A second substrate, or lid, 18 is adhered to the spacer 14. The lid 18 comprises a 50 μm PET tape (Adhesive Research 90119) coated with about 12.5 μm of a hydrophilic heat-seal adhesive ‘HY9’. The lid 18 is provided with a narrow vent 19 to permit the exit of air from the capillary flow path. The vent 19 need not extend right across the lid 18 but could comprise a hole or short slot in fluid communication with the capillary flow path. Finally, the second substrate 18 is guillotined to produce the biosensor 20. Alternatively the spacer 14 could, of course, be initially adhered to the second substrate 18 and then adhered to the first substrate. A benefit of this arrangement is that the second substrate 18 may be cut to provide the vent 19 while both parts of the second substrate 18 are held in the correct positions by the spacer 14.

The biosensor 20 has a reference electrode 22 and a working electrode 24 which are defined by the working area 12 in the dielectric layer 10. The working electrode 24 comprises the base layer 8 on a conductive carbon layer 4 on the first substrate 2, and a top layer including the buffer. The working electrode 24 and reference electrode 22 are connectable to a test meter (not shown) via conductive tracks 4, 6 on the base substrate 2.

In large-scale manufacturing, a plurality of substrates may be provided initially connected together on a single blank or web, preferably two substrate-lengths deep, and the various processing steps carried out on the entire blank or web, followed by a final separation step to produce a plurality of biosensors 20.

The biosensor 20 has a capillary flow path defined by the channel 16 in the spacer 14, the inner surface of the lid 18, and the first substrate 2 (largely covered by the dielectric layer 10). The flow path extends from the parallel short edges of each of the substrates 2, 18 to the reference and working electrodes 22, 24. The inner surface of the lid 18 is treated to be hydrophilic to facilitate wetting by blood. With glucose oxidase as the enzyme, the biosensor is used to measure blood glucose. A user may take a reading by pricking an alternative site such as his or her upper arm to produce a small drop of blood on the skin, and touching the appropriate short edge of the biosensor 20 to the skin where the blood is located. The blood is drawn rapidly to the working area 12, producing a current readable by a meter (not shown) connected to the conductive tracks 4 in a known manner. A sample volume of about 0.8 nl is sufficient. However, if an insufficient sample volume is applied, an inaccurate reading may result. Application of a second sample will then cause a non-faradaic charging peak, as will be discussed later.

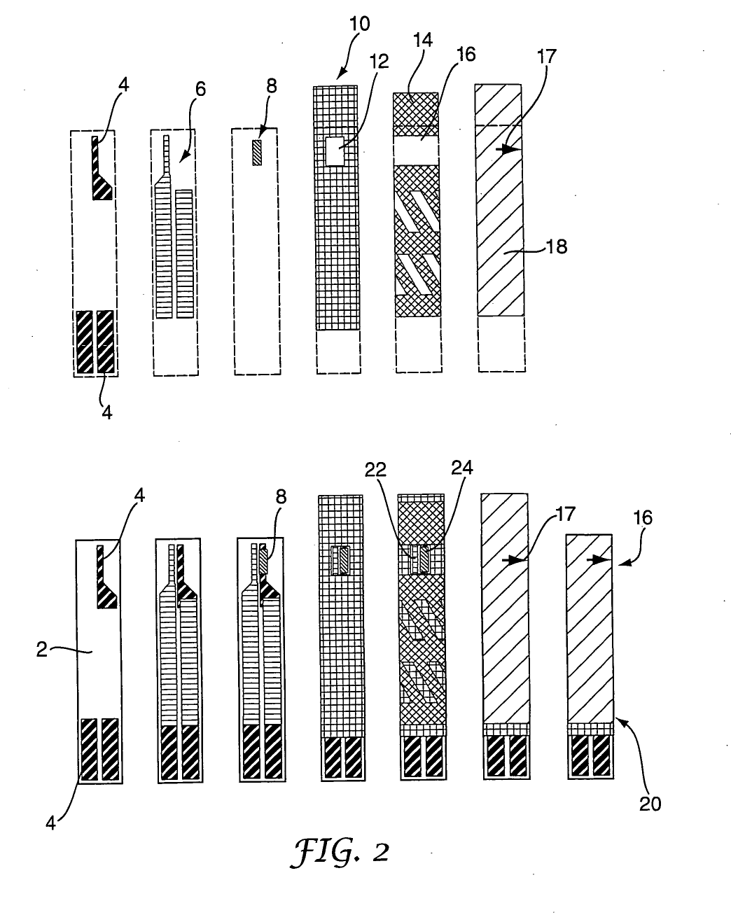

An embodiment of the present invention is shown in FIG. 2. The process steps are the same as for FIG. 1 except as follows. The spacer 14 is formed by screen-printing a UV-curable resin (Nor-Cote 02-060 Halftone Base) on the dielectric layer 10 and then curing the resin with UV light (120 W/cm medium pressure mercury vapour lamp) at up to 30 m/min. The resin comprises acrylated oligomers (29-55%) N-vinyl-2-pyrrolidone (5-27%) and acrylated monomers (6-28%). The channel 16 in the spacer 14 extends from one long edge of the biosensor to the other, for allowing air to exit the capillary flow path. The lid 18 does not require a vent exit, and is formed as a single unit having an inner surface coated with a hydrophilic heat-sealable adhesive (Adhesive Research 90119 coated with ‘HY9’). The lid 18 is adhered to the spacer 14 by the action of heat and pressure (100° C., 400 kPa) for 1-2 seconds. Application of a blood sample to the right hand side of the biosensor (as shown) at the channel 16 causes the blood to flow along a flow path through the capillary channel 16, where the first electrode encountered by the sample is the working electrode 24. The sample will not make contact with the reference electrode 22 until it has substantially covered the working electrode 24. Consequently, measurement of glucose concentration will not begin until the working electrode has been covered, thereby reducing the likelihood of an inaccurate reading. If double dosing is needed, only a single non-faradaic charging peak will occur. The sample-application region (in this example, at the right hand side of the biosensor) may be indicated to the user by suitable means 17, in this example a printed arrow and/or instructions on the lid 18. For efficiency of operation, the working electrode 24 occupies substantially all of the width of the capillary flow path (ie, measured in a direction normal to the direction of sample flow). The reference electrode 22 is of similar width.

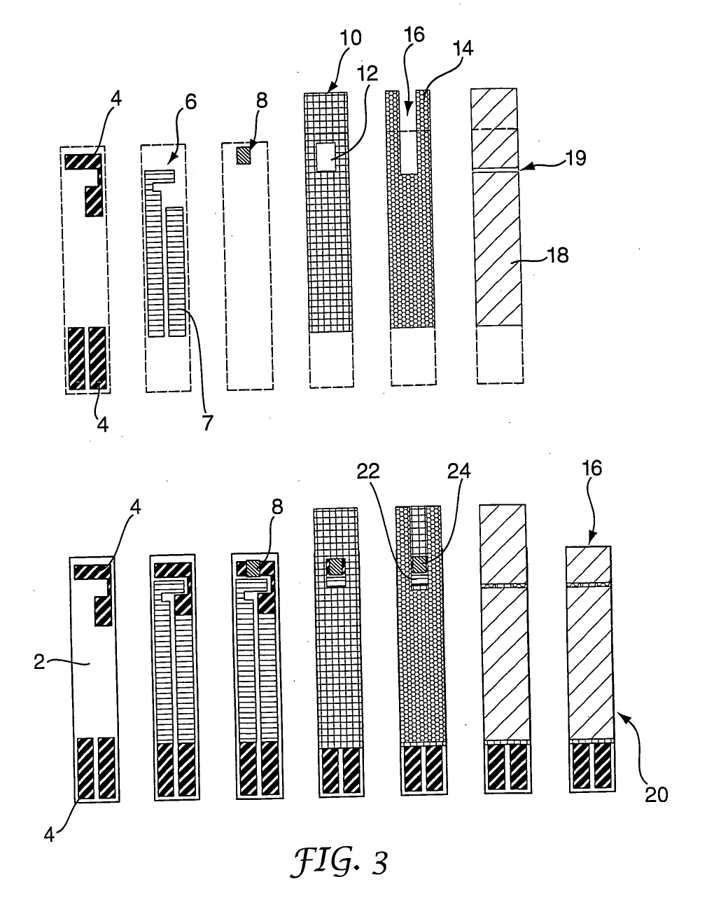

Referring now to FIG. 3, a further embodiment of the invention is illustrated. In this embodiment the layers are formed from the same materials processed in the same way as the biosensor of FIG. 1. For biosensors which will be stacked on top of each other, for example in a magazine or cartridge in a test meter, it is desirable to reduce or eliminate oozing of adhesive from the edges of the substrates, which might tend to cause adjacent biosensors to adhere to each other. A preferred material for use as the spacer 14 for this purpose is product code 61-89-03 from Adhesives Research Ireland Limited, Raheen Business Park, Limerick, Ireland. The spacer material comprises pressure sensitive adhesive (PSA) 25-29 μm on each side of a 36 μm PET film. A further alternative spacer is product code 64-14-04, also from Adhesives Research Ireland Limited, which has a UV-curable PSA on each side of a 23 μm PET film. The adhesive layers are each 31-35 μm thick. Recommended curing conditions are: D-bulb (Hg doped with Fe), 1 lamp, full power, 20 m/min. belt speed. Expected energy at these settings: UVA=357 J/cm², UVB=0.128 J/cm², UVC=0.010 J/cm².

As in the embodiment of FIG. 2, the working electrode 24 and the reference electrode 22 are arranged so that the working electrode 24 is the first electrode that a fluid sample will make contact with as it flows along the capillary flow path 16 from the top short edge of the biosensor. The dimension of the reference electrode 22 in the direction parallel to the long edges of the biosensor was varied in modifications of the embodiment of FIG. 3, to determine whether complete coverage of the reference electrode 22 is important in obtaining reproducible blood glucose readings. The gap between the working and reference electrodes was kept constant.

TABLE 1
Dimensions of Experimental Comparative and New Biosensors in millimetres.

| | | Working | Working | Active | Reference | Reference | Reference |
|---|---|---|---|---|---|---|---|
| Design | Batch | Width | Height | Area | Width | Height | Area |
| 1. FIG. 1 | 10007 | 1 | 3 | 3.00 | 0.6 | 3.5 | 2.1 |
| 2. FIG. 3 | 10010 | 1.55 | 1.95 | 3.02 | 2.05 | 1.42 | 2.91 |
| 3. FIG. 3 | 10008 | 1.55 | 1.95 | 3.02 | 2.05 | 1.00 | 2.05 |
| 4. FIG. 3 | 10011 | 1.55 | 1.95 | 3.02 | 2.05 | 0.64 | 1.31 |
| 5. FIG. 3 | 10012 | 1.55 | 1.95 | 3.02 | 2.05 | 0.30 | 0.62 |

Table 1 summarises widths (measured parallel to the short edges of the biosensor 20) and heights (measured parallel to the long edges of the biosensor 20) for working electrodes 24 and reference electrodes 22 of a comparative biosensor made to the design of FIG. 1, and four biosensors in accordance with the present invention, to the design of FIG. 3. Results are discussed below.
Test Procedure

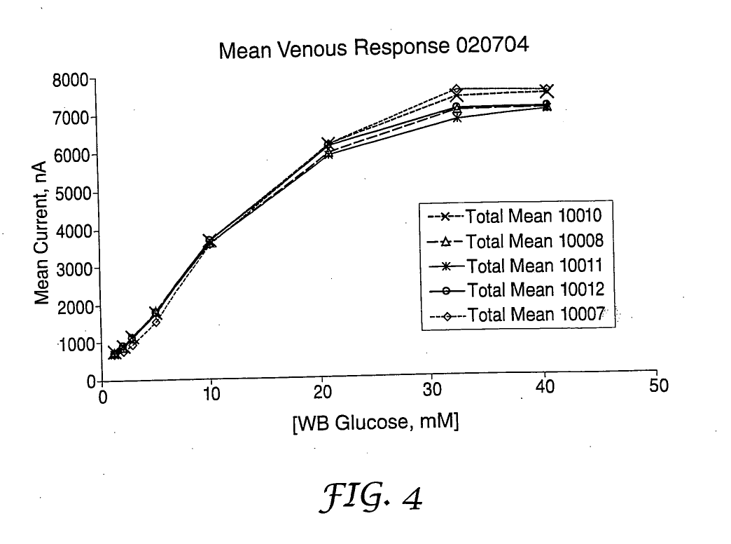

The test procedure involves connecting the test strips to a potentiostat. A potential of 350 mV is applied across the working and reference electrodes after application of a sample, in these examples a sample of venous whole blood (WB). The potential is maintained for 15 seconds, after which the current is measured; this current is used to prepare response graphs. Results for whole blood samples having different glucose concentrations are shown in FIG. 4. It can be seen that the size of the reference electrode only has an effect at the highest glucose concentrations, where a thinner reference electrode marginally depresses the measured concentration. These results suggest that under-filling a biosensor by not completely covering the reference electrode would have only a very small effect on the measured result, unlike the comparative biosensor where the same sample volume would lead to an incompletely covered working electrode and hence reduced measured values.

Design 3 was chosen for further evaluation as its performance was comparable to the other designs but also because it was almost identical in the surface areas of working and reference electrodes to the comparative biosensor (Design 1).

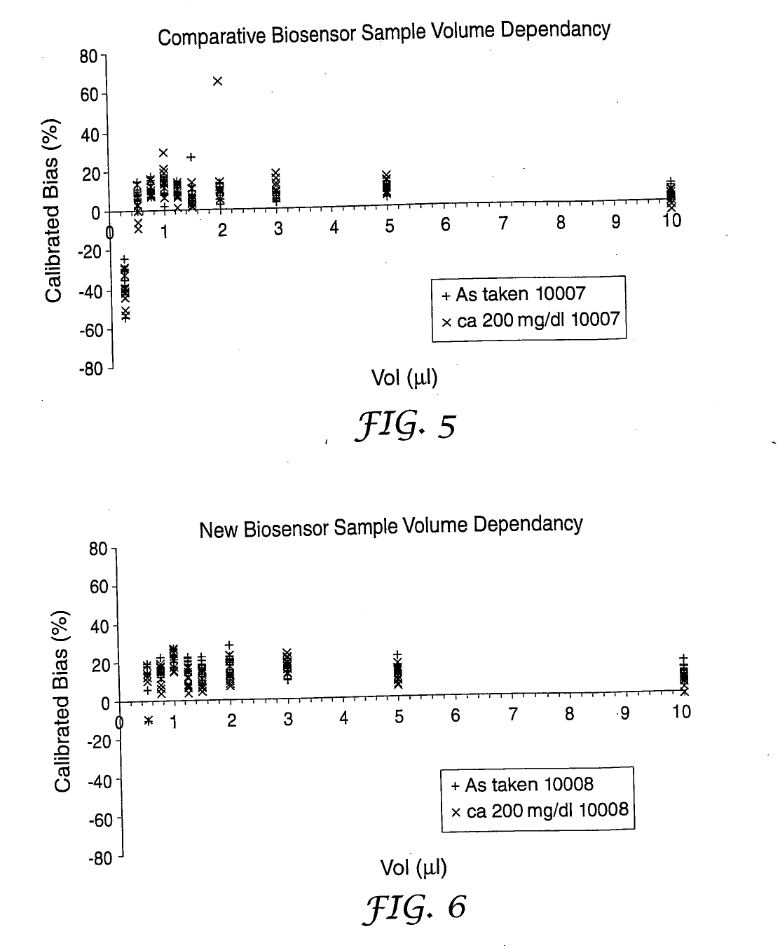

Sample volume determination experiments clearly show the advantage of the electrode geometry of the invention, with no erroneous under-fill results for the new biosensors, whilst the comparative biosensor has results depressed by about 50% for 0.25 μl samples (FIGS. 5 and 6). Both biosensors demonstrated the capability of measuring down to 0.5 μl, a volume smaller than the capillary space but probably sufficient to cover the working electrode entirely for both designs.

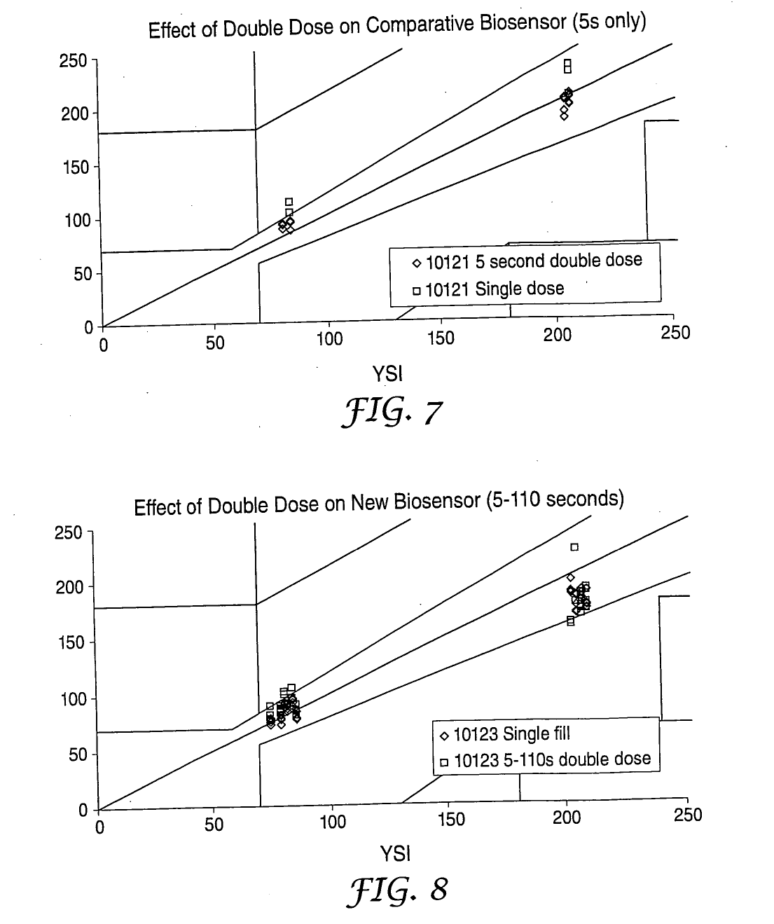

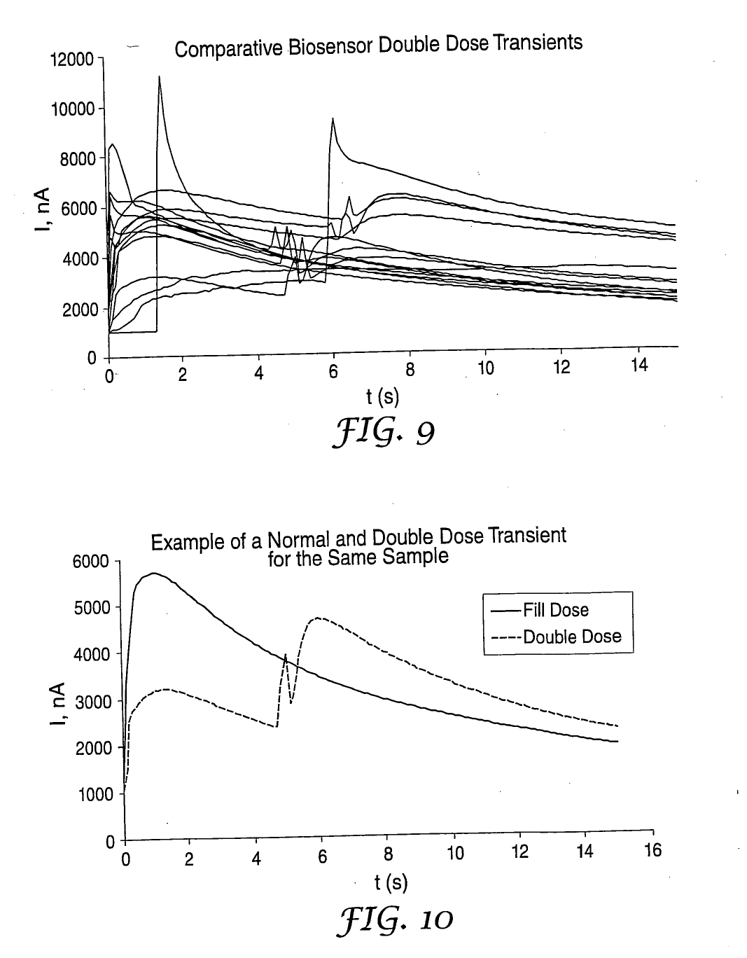

Double dosing results are shown in FIGS. 7 and 8. It was not possible to double dose the comparative biosensor (Design 1) with a delay of more than 7 seconds between doses because the test meter used in the experiments has a transient detection algorithm which detects the second dose and reports an error. However, if the first dose for the new biosensor (Design 3) is sufficient only to cover the working electrode and not reach the reference electrode then the second dose does not appear to have a significant effect on the strip response even when applied after a delay of up to 110 seconds (FIG. 8). Double dosing the comparative biosensor within 7 seconds does increase the measured result because of the extra non-faradaic charging spike induced by the second addition of blood. This is clear to observe from the current transients of double dose results for the comparative biosensor (FIGS. 9 and 10).

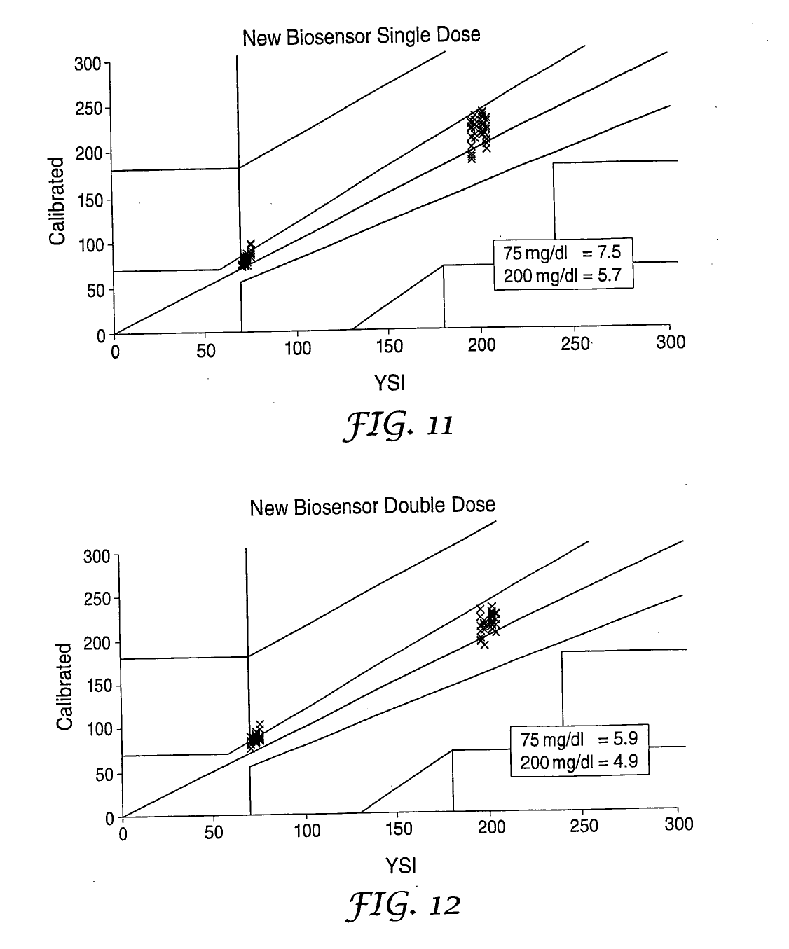

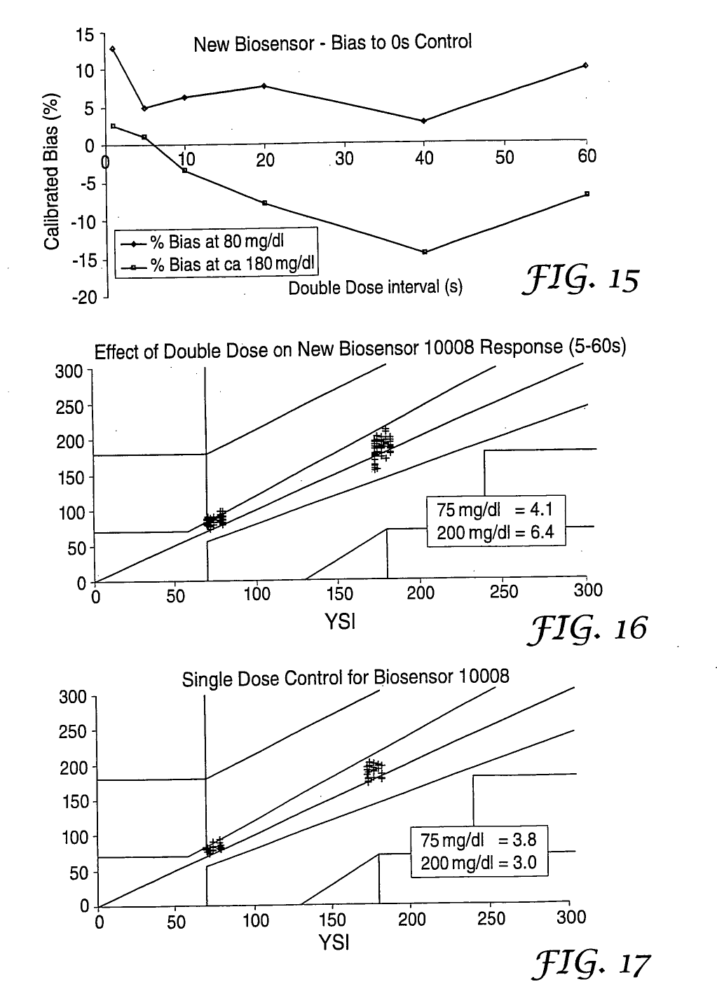

Further experimental work on double dosing was carried out on the comparative and new biosensors, the results of which are shown in FIGS. 11-19. FIGS. 11 and 12 show results for a new biosensor (Design 3) with, respectively, single dosing and double dosing of venous blood (7 second delay). The vertical axis charts glucose concentration values measured with a meter and the horizontal axis charts glucose concentration values measured with a YSI laboratory glucose analyser. Each data set contains 45 data points. Coefficient of Variation (CV) results are given in Table 2, where CV is calculated as Standard Deviation divided by mean and expressed as a percentage.

TABLE 2

| | 75 mg/dl | 200 mg/dl |
|---|---|---|
| Single Dose | 7.5 | 5.7 |
| Double Dose | 5.9 | 4.9 |

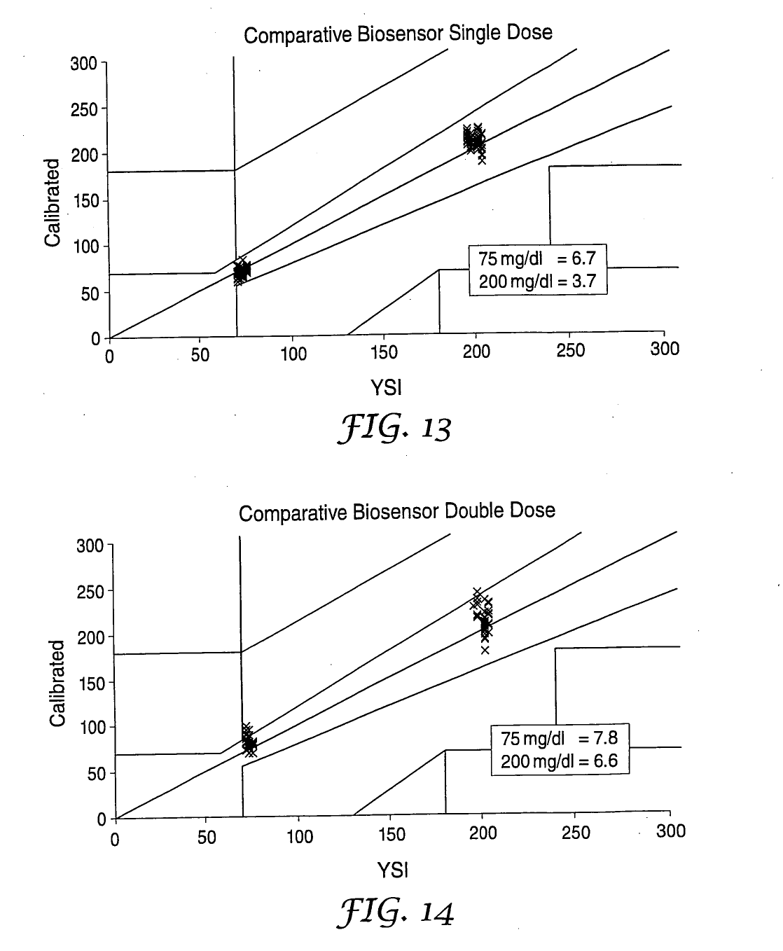

Comparable results are plotted in FIGS. 13-14 for the comparative biosensor (Design 1), with CV values given in Table 3.

TABLE 3

| | 75 mg/dl | 200 mg/dl |
|---|---|---|
| Single Dose | 6.7 | 3.7 |
| Double Dose | 7.8 | 6.6 |

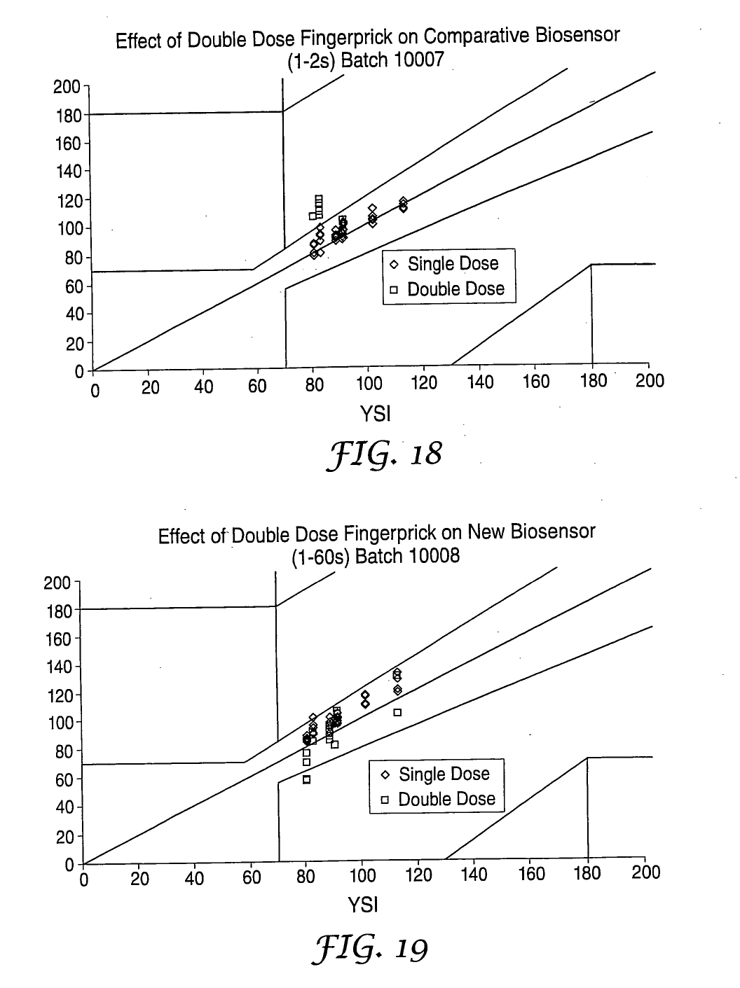

Double dosing of the comparative biosensor with a 7 second delay had the effect of reducing precision and increasing the response. The response increases as the addition of extra blood causes an extra non-faradaic charging peak to occur, which is less likely to happen when a biosensor of the present invention is used because there must be enough blood to form an electrical connection between the working and counter electrode for the measurement reaction to start. The effect of double dosing for the new biosensor was to cause a small increase in response at low glucose levels (ca. 75 mg/dl) and a decrease in response for mid range glucose concentrations (FIGS. 11, 12, 15, 16, 17 and 19). The biggest change was observed with the capillary experiments, perhaps because it is harder to control double dosing when squeezing blood from a finger (FIGS. 18 and 19). Blood is generally obtainable from a finger in sufficient quantity for single-fill operation. Short-fill is a more important issue when blood is sampled from alternative sites such as an upper arm or forearm.

It is appreciated that certain features of the invention, which are for clarity described in the context of separate embodiments, may also be provided in combination in a single embodiment. Conversely, various features of the invention which are, for the sake of brevity, described in the context of a single embodiment, may also be provided separately or in any suitable subcombination.

While the present invention has been described with reference to specific embodiments, it should be understood that modifications and variations of the invention may be constructed without departing from the spirit and scope of the invention defined in the following claims.

1. A biosensor for indicating electrochemically the catalytic activity of an enzyme in the presence of a biological fluid containing an analyte acted upon by said enzyme, the biosensor comprising:
(a) a first substrate;
(b) a second substrate overlying at least a part of the first substrate;
(c) a working electrode on one of the substrates, the working electrode including a catalytically-active quantity of said enzyme;
(d) a counter electrode on one of the substrates;
(e) conductive tracks connected to said working and counter electrodes for making electrical connections with a test meter apparatus;
(f) a spacer layer having a channel therein and disposed between the first substrate and the second substrate, the spacer layer channel co-operating with adjacent surfaces to define a capillary flow path which extends from an edge of at least one of said substrates to said electrodes;
wherein the electrodes are arranged such that a fluid sample which flows along the capillary flow path from said edge will substantially completely cover the working electrode before the fluid sample makes contact with any part of the counter electrode.

2. A biosensor according to claim 1, wherein the working electrode occupies substantially the entire width of the capillary flow path.

3. A biosensor according to claim 1, wherein the working electrode is the first electrode that a fluid sample will encounter when it flows along the capillary flow path.

4. A biosensor according to claim 3, wherein the working and counter electrodes are the only electrodes of the biosensor.

5. A biosensor according to claim 1, which is provided with a sign to indicate the entry point for a fluid sample into the capillary flow path.

6. A biosensor according to claim 1, wherein the biosensor has two parallel long edges and two parallel short edges, and wherein the capillary flow path extends from one long edge of the biosensor to the other long edge.

7. A biosensor according to claims 1, wherein the biosensor has two parallel long edges and two parallel short edges, and wherein the capillary flow path extends from one short edge of the biosensor to an opening in a substrate of the biosensor.

8. A biosensor according to claim 1, wherein the working electrode and the counter electrode are provided on the same substrate.

9. A biosensor according to claim 1, wherein the counter electrode also functions as a reference electrode.

10. A biosensor according to claim 1, wherein the working electrode includes:
(a) an electrically-conductive base layer comprising particles of finely divided platinum-group metal or platinum-group metal oxide bonded together by a resin;
(b) a top layer on the base layer, said top layer comprising a buffer; and
(c) a catalytically-active quantity of said oxidoreductase enzyme in at least one of said base layer and said top layer.

11. A biosensor according to claim 10, wherein the buffer is selected from a group comprising: phosphate, ADA, MOPS, MES, HEPES, ACA, and ACES, or buffers with a pKa 7.4±1.

12. A biosensor according to claim 10, wherein the buffer has a pH in the range 7 to 10.

13. A biosensor according to claim 12, wherein the buffer has a pH in the range 7 to 8.5.

14. A biosensor according to claim 10, further including a system stabiliser in the top layer, comprising a polyol which is not acted upon by the enzyme.

15. A biosensor according to claim 14, wherein the system stabiliser is trehalose.

16. A biosensor according to claim 1, wherein the enzyme is glucose oxidase.

17. A biosensor according to claim 10, wherein the base layer also contains particles of finely-divided carbon or graphite.

18. A biosensor according to claim 17, wherein said finely divided particles of platinum group metal or oxide are carried on the surface of the finely-divided carbon or graphite.

19. A biosensor according to claim 17, wherein the base layer further includes a blocking agent for blocking active sites of the carbon or graphite particles.

20. A biosensor according to claim 19, wherein said blocking agent comprises a protein or a polyol.

21. A biosensor according to claim 20, wherein the blocking agent is bovine serum albumin (BSA) or trehalose.

22. A biosensor according to claim 10, wherein said oxidoreductase enzyme is located substantially in said top layer.

23. A biosensor according to claim 10, wherein the ratio of buffer to enzyme is in the range 10-70 mol/kg.

24. A biosensor according to claim 23, wherein the ratio of buffer to enzyme is in the range 20-40 mol/kg.

25. A biosensor for indicating electrochemically the catalytic activity of an enzyme in the presence of a biological fluid containing an analyte acted upon by said enzyme, the biosensor including a capillary flow path extending from an entry location to an air vent location and including in the capillary flow path a counter electrode and a working electrode with a catalytically-active quantity of said enzyme; wherein the entire working electrode is located closer to the entry location than any part of the counter electrode.

26. A method of manufacturing a biosensor for indicating electrochemically the catalytic activity of an enzyme in the presence of a biological fluid containing an analyte acted upon by said enzyme, the method comprising the steps of:
providing a first substrate and a second substrate overlying part of the first substrate;
one of said substrates having a working electrode thereon including a catalytically active quantity of said enzyme and one of said substrates having a counter electrode thereon, each of said electrodes having a conductive track connected to it for making an electrical connection with a test meter apparatus;
providing a spacer layer having a channel therein and disposed between the first substrate and the second substrate, whereby the spacer layer channel and adjacent surfaces together define a capillary flow path which extends from an edge of at least one of said substrates to said electrodes;
wherein the electrodes are arranged such that a fluid sample which flows along the capillary flow path from said edge will substantially completely cover the working electrode before the fluid sample makes contact with any part of the counter electrode.
